(19) United States
(12) Patent Application Publication
(10) Pub. No.: US 2011/0320924 A1
(43) Pub. Date: Dec. 29, 2011

(54) HANDWRITTEN PAPER-BASED INPUT DIGITAL RECORD MANAGEMENT

(75) Inventors: Aishwarya Lakshmi Ratan, Bangalore (IN); Pushkar V. Chitnis, Bangalore (IN); Sunandan Chakroborty, Kolkata (IN)

(73) Assignee: Microsoft Corporation, Redmond, WA (US)

(21) Appl. No.: 12/822,131

(22) Filed: Jun. 23, 2010

(51) Int. Cl. G06F 17/00; G06F 3/01; G06F 21/00

(52) U.S. Cl. 715/226; 726/26; 715/702

(57) ABSTRACT

A handwritten paper-based input digital record management system and method to facilitate record management by directly accepting handwritten pen-based data input on ordinary paper forms. A user places a paper form on the digitizing surface of a digital computing device and then fill outs the form using handwritten input. A digital version of the handwritten form is simultaneously generated and presented on the screen of the computing device. Embodiments of the system and method also provide instantaneous form updating for any current data and reports any upcoming information that may be needed in the future. This mitigates the need for remote processing of the form. Moreover, embodiments of the system and method enforce completeness of the form and ensure that all necessary sections of the form are completed. Embodiments of the system and method also provide error correction by reconciling any invalidated data found during verification.

### BACKGROUND

Many administrative and financial processes require a user to enter handwritten data on ordinary paper forms. Handwritten data on paper forms typically requires post processing at a computer, involving scanning, digitizing, recognizing the input image, and processing of the data. This is all performed before the user receives feedback. The other alternative involves manual transcription by a human agent into a digital database by re-typing the data at a computer. Both of these processes have drawbacks such as redundancy, high cost (cost of equipment required for processing), long time delays, and errors from the transcription process.

One proposed technique uses a digital pen such that text written on plain paper can be memorized and later transferred to a PC either as an image or recognized text and digits from the pen. However, in some cases, this technique requires the use of specialized paper. Moreover, the data stored on the pen cannot be processed in reference to a database without a personal computer.

A different approach involves writing on a digitizing surface computing device (such as a digital tablet) with a digital pen. However, few of these mechanisms have the capability to provide immediate electronic feedback to handwritten input on regular paper, in reference to an external database, all at low-cost. From a usability perspective, the value of pen input on paper has been repeatedly recognized. For instance, previous work assessing support tools for students working on math problems confirmed that pen and paper are preferred. Even in richer countries where digital media are widely prevalent, ink input on paper is still a preferred mode for preparing notes.

One area where paper forms are used frequently is in the financial arena. In particular, the prospect of improving front-end record management in microfinance using technology has met with much enthusiasm over the past decade. Prototype solutions to enable transaction record management have been designed using camera-enabled mobile phones, smartphones, handheld devices, and even laptops. Many of these solutions have focused on the Grameen-Bank model of joint-liability microfinance delivery. However, there are many types of microfinance models that use a decentralized autonomous structure and self-run process for which this model does not apply.

Most of these solutions have not attained scaled deployment. The cost of investment in the technology-enabled channel is often too high to allow for financial viability over a reasonable timeframe for microfinance institutions. Because application development and testing are often performed in isolation, there have been problems in integrating the prototype solution into regular microfinance workflows given field and operational constraints. Moreover, clients frequently exhibit a strong preference for maintaining a local paper record for reference, which has dampened the desire for purely electronic data collection systems where no paper trail is left.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Embodiments of the handwritten paper-based input digital record management system and method facilitate record management by directly accepting handwritten pen-based data input on ordinary paper forms. Existing tablet PC interfaces do not allow for the simultaneous creation of a digital record and handwritten paper form. Embodiments of the system and method also provide immediate visual and audio feedback of any data entered or generated. Users of embodiments of the system and method are able to comfortably move between paper and digital worlds, achieving efficiency and quality gains while remaining relatively inexpensive and catering to the preferences and budgets of low-income and low-literate users.

Embodiments of the system and method have a user place a paper form on the digitizing pad (or surface) of a digital computing device. The user fills out the form using handwritten input. A digital version of the handwritten form is simultaneously generated and presented on the screen of the computing device (which typically is a mobile or portable computing device). The handwritten data is at the same time processed in reference to a database that is stored on the computing device. Users receive feedback on their records instantly both visually and through audio output. The user interaction allows natural entry of handwritten data on the paper form, just as would have been the case had there been no computing device involved. Embodiments of the system and method accept handwritten data on regular paper, digitize the input in real time, and executes processes and computations targeted for specific domains. Some of the advantages include instantaneous feedback, real-time error-checking, data completeness and improved process (or task) efficiency.

Embodiments of the system and method also provide instantaneous form updating. In particular, the form is updated in real time to provide any current data and to report any upcoming information that may be needed in the future. This mitigates the need for remote processing of the form. Moreover, embodiments of the system and method enforce completeness of the form and ensure that all sections of the form are completed. The result is a completed paper version of the form as well as a completed electronic version of the form.

It should be noted that alternative embodiments are possible, and that steps and elements discussed herein may be changed, added, or eliminated, depending on the particular embodiment. These alternative embodiments include alternative steps and alternative elements that may be used, and structural changes that may be made, without departing from the scope of the invention.

### DRAWINGS DESCRIPTION

Referring now to the drawings in which like reference numbers represent corresponding parts throughout:

FIG. 1 is a block diagram illustrating a general overview of embodiments of a handwritten paper-based input digital record management system and method implemented on a computing device.

FIG. 2 is a flow diagram illustrating the general operation of embodiments of the handwritten paper-based input digital record management system shown in FIG. 1.

FIG. 3 is a flow diagram illustrating the operational details of embodiments of the paper form determination module shown in FIG. 1.

FIG. 4 is a flow diagram illustrating the operational details of embodiments of the record generation module shown in FIG. 1.

FIG. 5 is a flow diagram illustrating the operational details of embodiments of the audio verification module shown in FIG. 1.

FIG. 6 is a flow diagram illustrating the operational details of embodiments of the data verification module shown in FIG. 1.

FIG. 7 is a flow diagram illustrating the operational details of embodiments of the error correction module shown in FIG. 1.

FIG. 8 is a flow diagram illustrating the operational details of embodiments of the dynamic update module shown in FIG. 1.

FIG. 9 is a flow diagram illustrating the operational details of embodiments of the completion and verification module shown in FIG. 1.

FIG. 10 illustrates an example of a suitable computing system environment in which embodiments of the handwritten paper-based input digital record management system and method shown in FIGS. 1-9 may be implemented.

### DETAILED DESCRIPTION

In the following description of embodiments of the handwritten paper-based input digital record management system and method reference is made to the accompanying drawings, which form a part thereof, and in which is shown by way of illustration a specific example whereby embodiments of the handwritten paper-based input digital record management and method may be practiced. It is to be understood that other embodiments may be utilized and structural changes may be made without departing from the scope of the claimed subject matter.

### I. System Overview

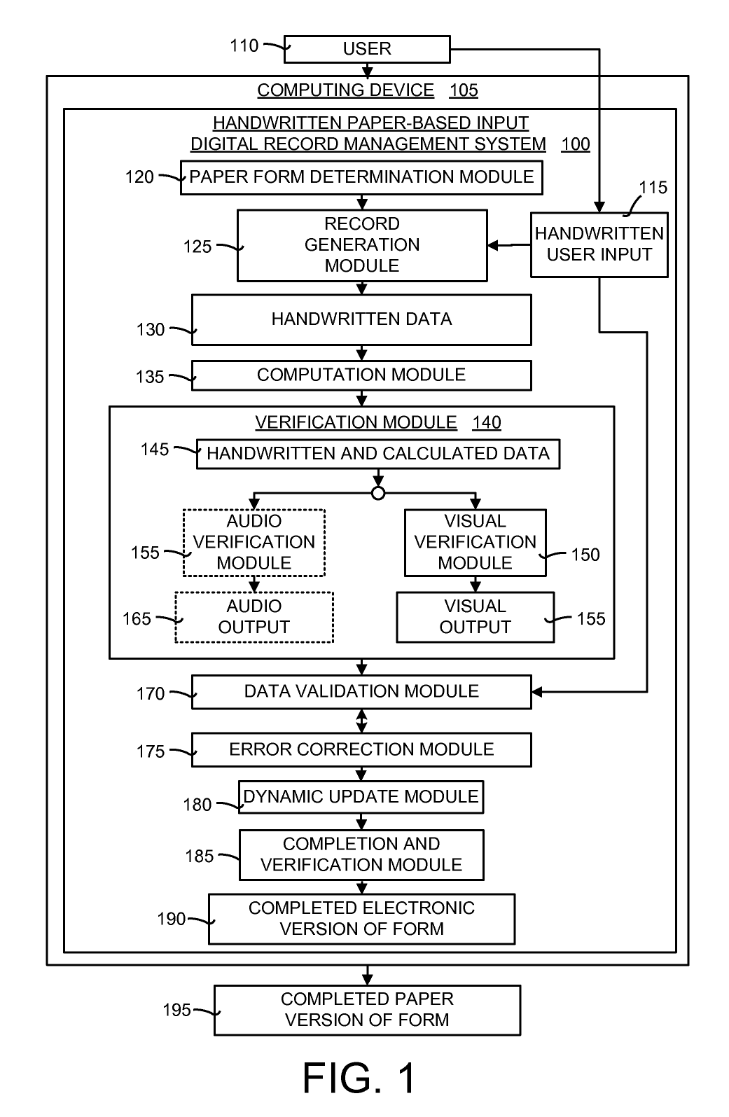

FIG. 1 is a block diagram illustrating a general overview of embodiments of a handwritten paper-based input digital record management system 100 and method implemented on a computing device 105. In some embodiments the computing device is a handheld digital slate. In general, embodiments of the handwritten paper-based input digital record management system 100 and method receive input from a user 110 writing on a paper form with an ink-based digital pen and simultaneously create a paper copy of the form and an electronic copy of the same record.

More specifically, embodiments of the handwritten paper-based input digital record management system 100 shown in FIG. 1 receive input by way of the user 110 placing a form (not shown) on the computing device 105 and writing on the form in the spaces provided with an ink-based digital pen (not shown). Writing on the form with the pen generates handwritten user input 115. Embodiments of the handwritten paper-based input digital record management system 100 and method include a paper form determination module 120 and a record generation module 125. Embodiments of the paper form determination module 120 are used to receive input as to which form is in use. This enables embodiments of the system 100 and method to know how the data will be formatted and what is left that is needed to complete the form. Embodiments of the record generation module 125 facilitate the simultaneous generation of both a paper copy and an electronic copy of the form based on input from the user 110.

The handwritten user input 115 will typically be either textual data, numerical data, character data, or any combination of these. Specific options (including text) can be used to select parameters for computation or input for database queries. Depending on the form being used, handwritten data 130 that may contains numerical data, textual data, or characters, may require computation. This handwritten data 130 is parsed from the handwritten user input 115. Embodiments of the system 100 and method also include computation module 135. Embodiments of the computation module 135 automatically compute any calculation required by the form being used. This alleviates the need for manual calculation and reduces errors. Embodiments of the computation module 135 can process both numerical data (either in character or text format) and textual data. For example, the paper form is a tax form and the tax rates are calculated differently for males and females, the user's input that she is a “female” is used by embodiments of the computation module 135 to compute results using the corresponding tax rate.

Embodiments of the system 100 and method also include a verification module 140. Embodiments of the verification module 140 include a visual verification module 150 and an optional audio verification module 155 (optional as shown by the dashed lines in FIG. 1. In general, embodiments of the verification module 140 are another verification tool to allow any data entered into or generated by embodiments of the system 100 and method to be verified either visually, audibly, or both. This is shown in FIG. 1 as visual output 160 (from embodiments of the visual verification module 150) and as audio output 165 (from embodiments of the audio verification module 155). The visual output 160 can be displayed to the user to aid the user in verify the data entered, and optionally the audio output 165 can be played to the use as audio feedback (such as a voiceover) to audibly verify the data entered and calculations computed.

Embodiments of the audio verification module 155 allow not only the user 110 but those around the user 110 (such as in a meeting setting) to listen to details of what is being entered on the form being used. Thus, using the audio output 165, even if a person is illiterate they can still be aware of what is being entered and recorded on the form being used.

Embodiments of the system 100 and method also include a data validation module 170 to validate the data being entered by the user. In particular, the handwritten user input 115 is run through validity checks to ensure that the data entered is valid. If the data is not valid, then embodiments of an error correction module 175 are used to reconcile the data. A dynamic update module 180 is used to provide instantaneous updates to the electronic version of the form being used when the user 110 enters data on the paper version of the form. This alleviates the need for remote processing of the form and provides self-contained local processing of the form. However, in some embodiments local processing can be augmented with remote processing.

Embodiments of the system 100 and method also include a completion and verification module 185. Embodiments of this module 185 enforce completeness and ensure that the entire form is filled out (or as much of the form is filled out as is required by the entity needing the form) as well as verify the data entered. The output of embodiments of the system 100 and method are a completed electronic version of the form 190 as well as a completed paper version of the form 195.

### II. Operational Overview

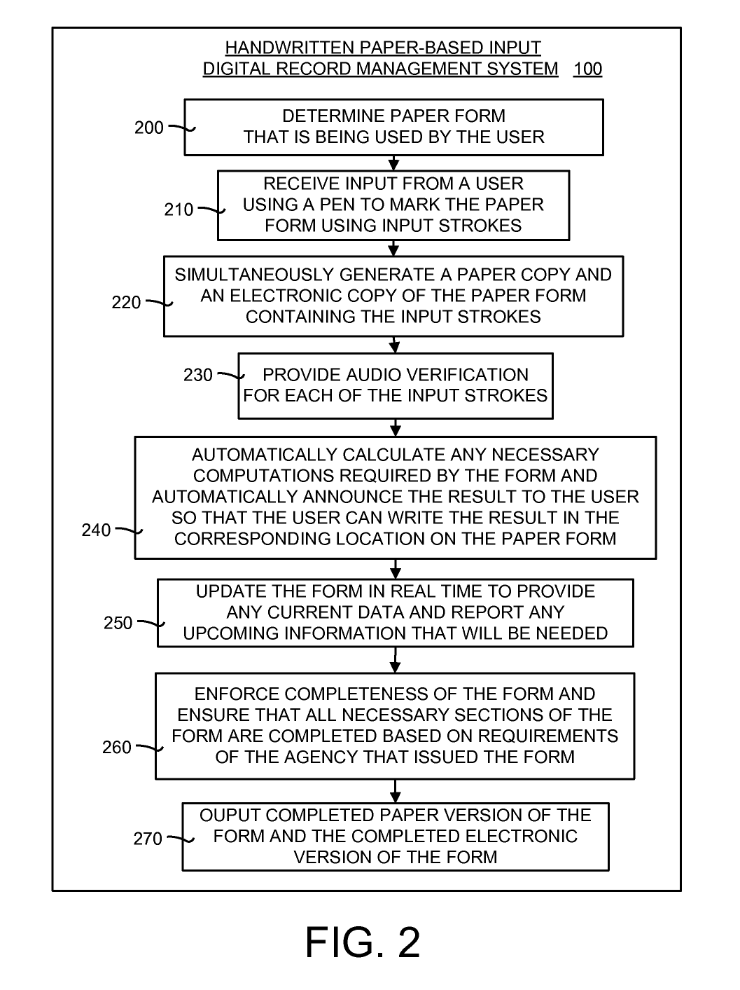

FIG. 2 is a flow diagram illustrating the general operation of embodiments of the handwritten paper-based input digital record management system 100 shown in FIG. 1. Referring to FIG. 2, the method begins by determining the paper form that is being used by the user (box 200). In some embodiments the user will enter the form number or some other way of identifying the form being used. In other embodiments the form will be automatically known by the computing device 105 (such as by way of a bar code).

Next, embodiments of the system 100 receive input from a user (box 210). This occurs by the user using a pen to mark the paper form using input strokes. This means there is a single point of data entry. Handwriting is a natural input mechanism for many people. Handwritten data entry serves to considerably lower the learning bar for the user to effectively use embodiments of the system 100 and method. The user writes by hand on the paper form and simultaneously generates a paper copy and an electronic copy of the paper form (box 220). In addition, each of the input strokes created by hand by the user are contained on the electronic copy or versions of the paper form. The digital data that is obtained from the user's input is immediately available for manipulation and processing as digital data.

Audio verification may be provided for each of the input strokes (box 230). In other words, any data entered into or generated by embodiments of the system 100 and method can be verified using audio feedback. This allows the user and even others, even if illiterate, to listen to details of the data being entered into the form and to point out any errors. Next, embodiments of the system 100 and method automatically calculate any computations required by the form (box 240). In addition, a result of the calculation is announced to the user so that the user can handwrite the result in the location on the paper form. This automatic calculation feature alleviates the need for manual calculation thereby reducing errors and allowing the form to be filled out faster.

Embodiments of the system 100 and method then update the form in real time to provide any current data and report any upcoming information that may be needed in the future (box 250). There is no dependence on or need for remote processing. However, in some embodiments real-time remote processing or querying of data may be used. Embodiments of the system 100 and method enforce completeness of the form and ensure that all necessary sections of the form are completed (box 260). Typically, the necessary sections that need to be completed on the form are dictated by an agency that issued the form. Finally, embodiments of the system 100 and method output the completed paper version of the form and the completed electronic version of the form (box 270). In some embodiments the electronic version of the form that is output is in a database format.

### III. System and Operational Details

Embodiments of the handwritten paper-based input digital record management system 100 and method provide an efficient and effective way to complete forms. The system and the operational details of embodiments of the handwritten paper-based input digital record management system 100 and method now will be discussed. These embodiments include embodiments of the paper form determination module 120, the record generation module 125, the audio verification module 155, the data validation module 170, the error correction module 175, the dynamic update module 180, and the completion and verification module 185.

### III.A. Digital Slate Computing Device

Embodiments of the handwritten paper-based input digital record management system 100 and method use a computing device 105 that is a handheld digital slate to hold the paper form and receive input from the user. In some embodiments the computing device 105 includes a digitizing pad on which ordinary paper or a book can be placed, and anything written in ink on the paper using the device's active ballpoint pen is simultaneously digitally captured as raw strokes. These types of devices typically are frequently used in educational settings and therefore are designed to be fairly inexpensive. In other embodiments of the system 100 and method computing devices that are not tablet or portable computing devices may be used. In addition, some embodiments of the system 100 and method use devices such as scanners, digitizing pens, or any type of device that can be used to fetch handwriting strokes of a user in real time. Moreover, in some embodiments the handheld digital slate is a mobile phone connected to a digitizing pad or surface along with an ink-based digital pan.

### III.B. Paper Form Determination Module

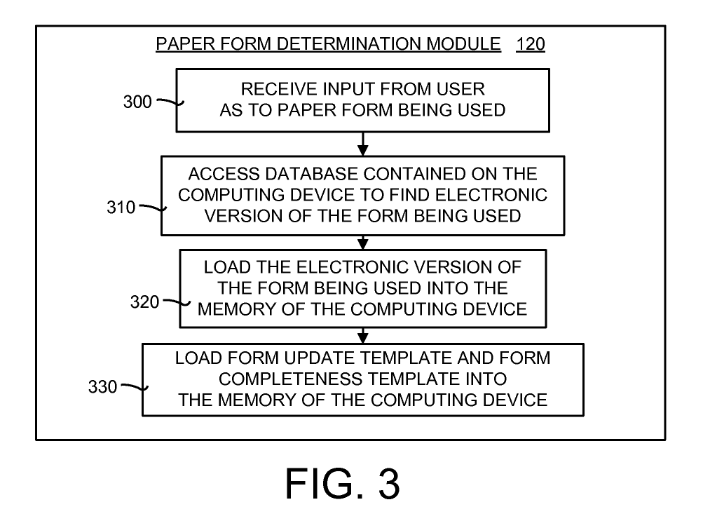

Embodiments of the handwritten paper-based input digital record management system 100 and method include a paper form determination module 120 to determine the type of paper form being used. FIG. 3 is a flow diagram illustrating the operational details of embodiments of the paper form determination module 120 shown in FIG. 1. The method begins by receiving input from the user as to the paper form that is being used (box 300). In alternate embodiments, embodiments of the system 100 will automatically determine the type of paper form being used (such as with a bar code).

Next, embodiments of the module 120 access a database on the computing device 105 that contains different electronic version of the forms and their corresponding electronic templates (box 310). In alternate embodiments these forms are not stored locally but are fetched from a remote site. The electronic version of the form being used is loaded into the memory of the computing device 105 (box 320). In addition, a dynamic update template, which contains information as to what information on the form may be updated, and a form completeness template, which contains information about which areas of the form need to be completed, are loaded into the memory of the computing device 105 (box 330).

### III.C. Record Generation Module

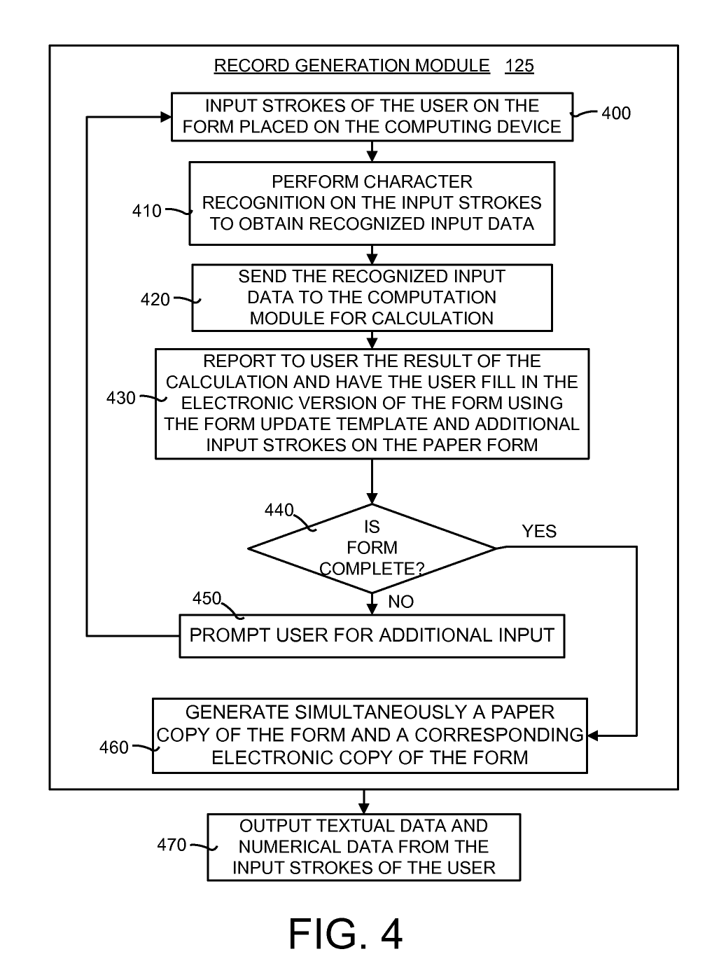

Embodiments of the handwritten paper-based input digital record management system 100 and method include a record generation module 125 to generate paper and electronic copies of the form. FIG. 4 is a flow diagram illustrating the operational details of embodiments of the record generation module shown in FIG. 1. The method begins by inputting strokes of the use on the form placed on the computing device 105 (box 400). Next, character recognition is performed on the input strokes to obtain recognized input data (box 410).

The recognized input data is sent to the computation module 135 for calculation (box 420). Embodiments of the module 125 then report to the user the results of the calculation (box 430). This result is used by the user to handwrite in the result on the paper form. This updates the electronic version of the paper form. Both the dynamic update template and additional input strokes by the user are used in this process.

embodiments of the module 125 then make a determination as to whether the form is complete (box 440). This is achieved using the information contained in the form completeness template. If the form is not complete, then the user is prompted for additional input as to the uncompleted parts of the form (box 450). The process then repeats itself with user handwriting input strokes on the paper form (box 400). If the form is complete, then embodiments of the module 125 generate simultaneously a paper copy of the form (that the user has filled out) and a corresponding electronic version of the form (box 460). The digital data from the user's input is immediately available for manipulation and processing. The output of embodiments of the module 125 are textual data and numerical data that are obtained from the input strokes of the user (box 470).

### III.D. Audio Verification Module

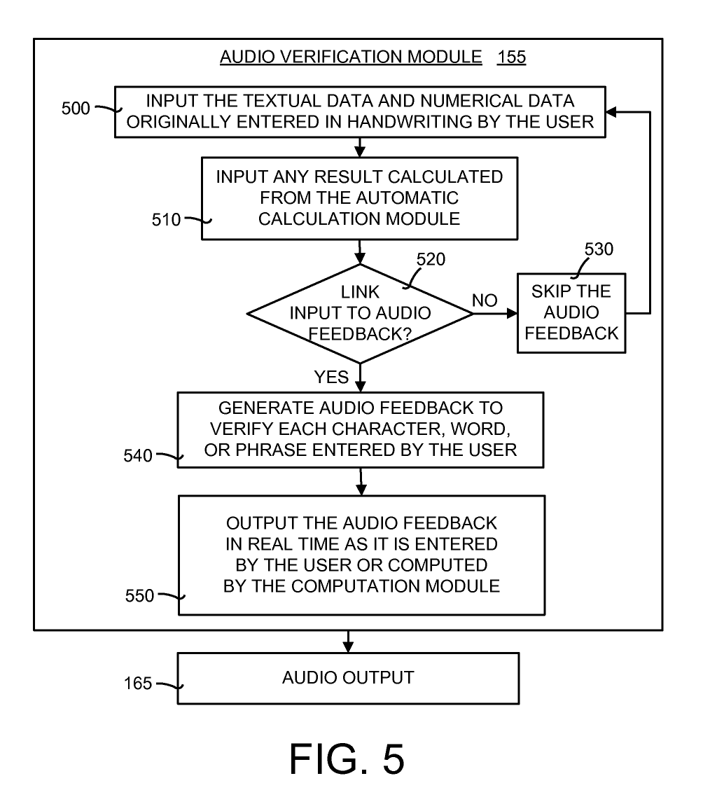

Embodiments of the handwritten paper-based input digital record management system 100 and method include an optional audio verification module 160 to audio verification of data entered by the user and results generated by the embodiments of the system 100. The audio verification module 160 is an optional module, as shown in FIG. 1 by the dashed lines. FIG. 5 is a flow diagram illustrating the operational details of embodiments of the audio verification module 160 shown in FIG. 1. The method begins by inputting the textual data and numerical data that was originally entered by the user in handwriting (box 500). In some embodiments of the module 140, each relevant input stroke has character recognition run on it and then it is input to embodiments of the audio verification module 160. In these embodiments audio feedback can be provided for relevant results and reports. In alternate embodiments, this process can be configured by the user. When a form is being designed, embodiments of the system 100 and method can identify fields and locations within the form where audio feedback is desirable and relevant and have it available either automatically or based on a user action (such as clicking on a button). In addition, any result that was calculated by embodiments of the computation module 135 is also input (box 510).

Next, embodiments of the audio verification module 140 make a determination as to whether the input is be to linked to the audio feedback (box 520). Generally, this involves any rule that links some input data to the audio feedback. In some embodiments this involves making a determination as to whether a field in the form does not receive new handwritten input from the user, or whether the field has a zero value, or whether a certain member of the group is present. If the answer is negative, then embodiments of the audio verification module 160 automatically skip the audio feedback (box 530). If the answer is in the affirmative, then embodiments of the audio verification module 160 generate audio feedback verify each character (including numbers and digits), word, or phrase that was entered by the user or generated by the embodiments of the system 100 (box 540). Embodiments of the module 160 then output the audio feedback as it was entered by the user or computed by embodiments of the computation module 135 (box 550). The output from embodiments of the module 140 is the audio output 165.

### III.E. Data Verification Module

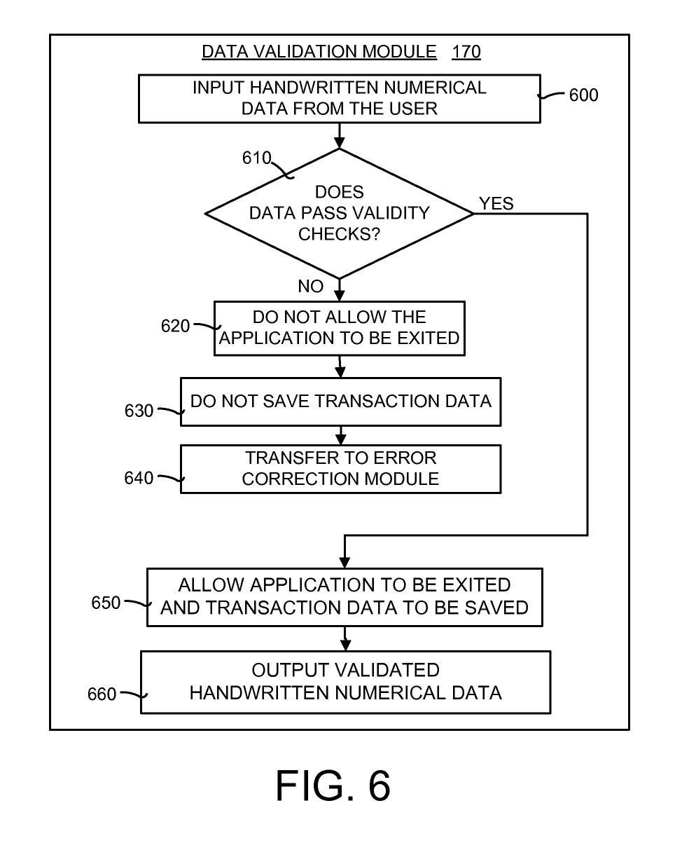

Embodiments of the handwritten paper-based input digital record management system 100 and method include a data verification module 170 to provide verification of data input from the user 110. More specifically, embodiments of the data verification module 170 review the handwritten data from the user and run it through validity checks. FIG. 6 is a flow diagram illustrating the operational details of embodiments of the data verification module 170 shown in FIG. 1. The method begins by inputting the handwritten numerical data from the user (box 600). Next, a determination is made as to whether the data passes validity checks (box 610). By way of example, validity checks include determining whether the data matches up and reconciles across multiple data fields.

If the data does not pass the validity checks, then the user 110 is not allowed to exit the application (box 620) and the user 110 is not allowed to save any transaction data (box 630). Instead, the user 110 is directed to embodiments of the error correction module 175 (discussed below) for reconciliation of the data (box 640). This improves the data accuracy of the form being filled out. If the data does pass the validity checks, then embodiments of the module 170 allow the user 110 to exit the application and to save the transaction data (box 650). The validated handwritten numerical data then is output (box 660).

### III.F. Error Correction Module

Embodiments of the handwritten paper-based input digital record management system 100 and method also include an error correction module 175 to reconcile any invalidated data found by embodiments of the data verification module 170. In addition, embodiments of the error correction module 175 map location and active regions of the paper form to specific digital functions.

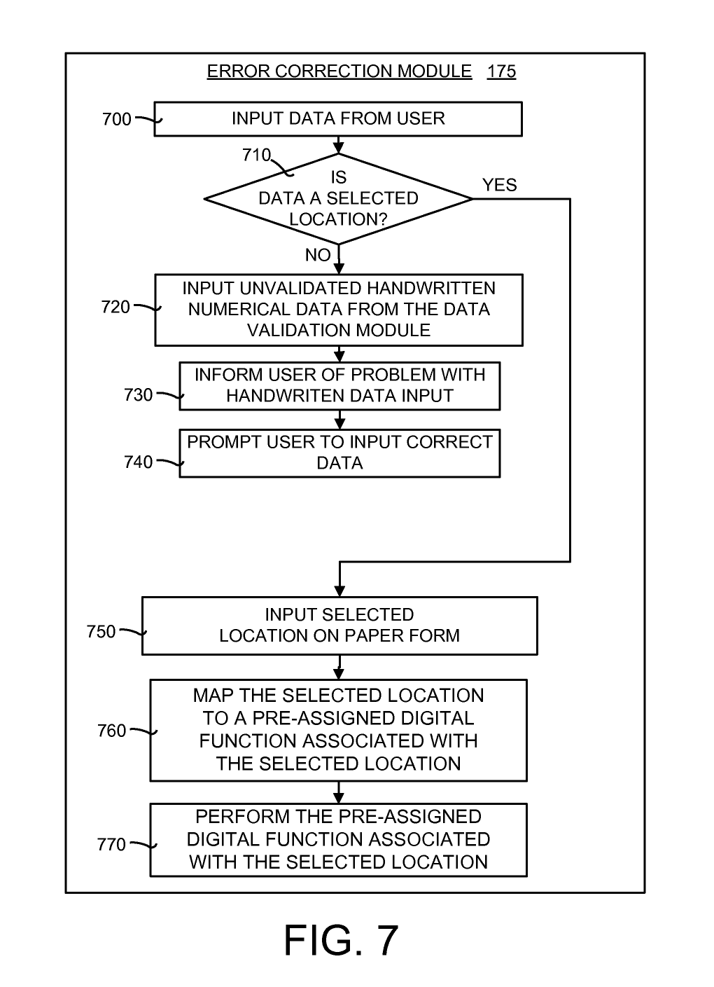

FIG. 7 is a flow diagram illustrating the operational details of embodiments of the error correction module 175 shown in FIG. 1. The method begins by inputting the data from the user 110 (box 700). Next, a determination is made as to whether the data is a location that has been selected by the user 110 (box 710). If no, then this means the data is the invalidated handwritten data sent from embodiments of the data validation module 170. In this case, the invalidated handwritten numerical data from embodiments of the data validation module 170 is input (box 720). Next, embodiments of the error correction module 175 inform the user 110 of the problem with the handwritten input data (box 730). In addition, embodiments of the module 175 prompt the user to input corrected data (box 740).

If the data is a selected location, embodiments of the module 175 input a selected location on the paper form (box 750). This means that the user 110 has selected a pre-assigned location on the paper form to perform some desired digital function. For example, the digital function may be a backspace or a save function. This allows the user 110 to perform digital functions (such as backspace and save) using the ink-based digital pen. Embodiments of the error correction module 175 then map the selected location to a pre-assigned digital function associated with the selected location on the digital form (box 760). The pre-assigned digital function then is performed by embodiments of the module 175 (box 770).

Embodiments of the error correction module 175 also facilitate many processing and navigation functions to be accessed using the pen and paper. In particular, each of the paper forms can contain “active regions” whereby specific regions on the form when pressed or selected by the user 110 performs a pre-assigned digital function. Active regions on the paper form allow navigational schemes using the paper surface as input. This alleviates the need to switch to a stylus or other modes of input (although other modes of input are allowed to augment the paper and pen input).

### III.G. Dynamic Update Module

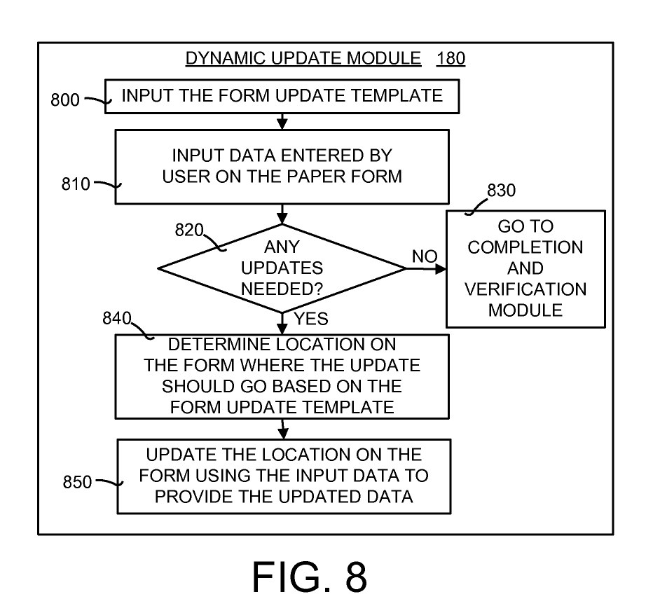

Embodiments of the handwritten paper-based input digital record management system 100 and method include a dynamic update module 180 to provide instantaneous updates as required by the paper form. More specifically, embodiments of the dynamic update module 180 update dynamic sections of the forms such that the sections automatically update or appear based on input entered in previous sections by the user. FIG. 8 is a flow diagram illustrating the operational details of embodiments of the dynamic update module 180 shown in FIG. 1. The method begins by inputting the form update template (box 800). Next, the data that was entered by the user on the paper form is entered (box 810). A determination then is made as to whether any updates are needed (box 820). If not, then the process continues on to the completion and verification module 185 (box 830).

If an update is needed, then embodiments of the module 180 determine the location on the form where the update goes (box 840). This is achieved using the form update template. The updated data then is placed at the location on the form where it is needed (box 850). In this way embodiments of the module 180 provide real time updating of the form.

### III.H. Completion and Verification Module

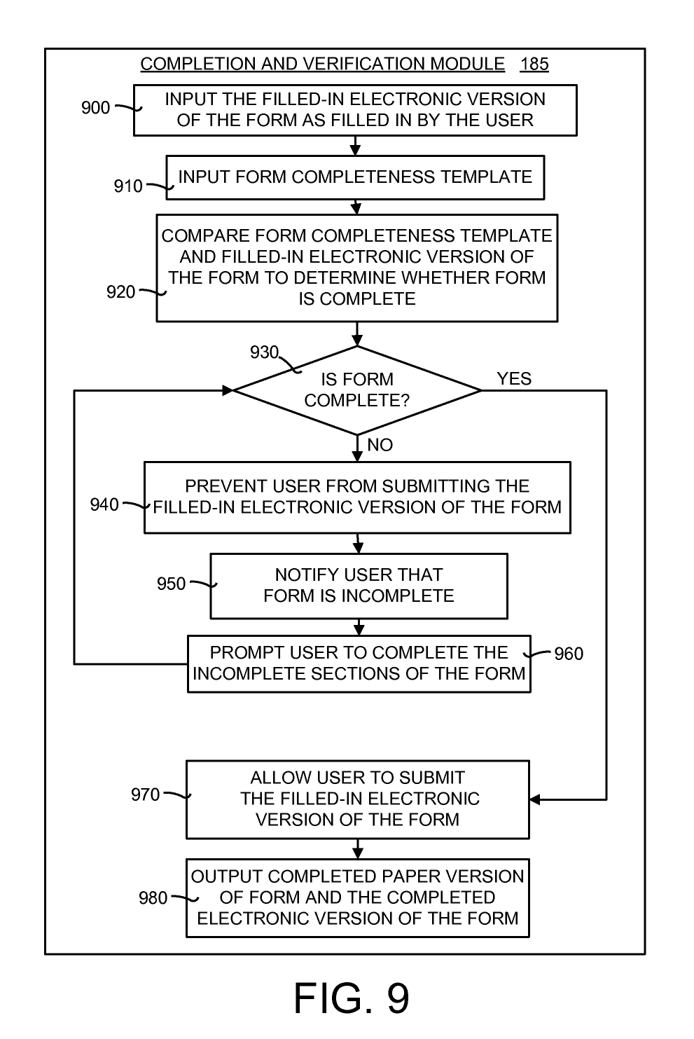

Embodiments of the handwritten paper-based input digital record management system 100 and method include a completion and verification module 185 to ensure that the form is completely filled out. More specifically, embodiments of the completion and verification module 185 perform completion checks to check for missing data and verifies the data to ensure that the data entered is valid. FIG. 9 is a flow diagram illustrating the operational details of embodiments of the completion and verification module 185 shown in FIG. 1. The method begins by inputting a filled-in electronic version of the form at filled in and completed by the user up to this point (box 900). The form completeness template also is input (box 910). Next, embodiments of the module 185 compare the form completeness template and the filled-in electronic version of the form to determine whether the form is complete (box 920).

A determination then is made as to whether the form is complete (box 930). If not, then some embodiments of the module 185 prevent the user from submitting the filled-in version of the form (box 940). In addition, embodiments of the module 185 send a notification to the user that the form is incomplete (box 950). Moreover, the user is prompted to complete the incomplete sections of the form (box 960). Embodiments of the module 185 continue this process until the form has been completed. In an alternate embodiment of the module 185, users are not allowed to save the uncompleted form until the form is completely and correctly filled in. In yet other embodiments, the user 110 is allowed to save the uncompleted form but the completed data to that point is verified and validated. In either embodiment the module 185 checks for completeness and data validity, such that the data is in proper syntax and adheres to business logic defined for the form system.

If the form is complete then the user is allowed to submit the filled-in electronic version of the form (box 970). This gives the user the incentive to complete the form. Once the form is complete, embodiments of the module 185 output the completed paper version of the form and the completed electronic version of the form (box 980).

### IV. Exemplary Operating Environment

Embodiments of the handwritten paper-based input digital record management system 100 and method are designed to operate in a computing environment. The following discussion is intended to provide a brief, general description of a suitable computing environment in which embodiments of the handwritten paper-based input digital record management system 100 and method may be implemented.

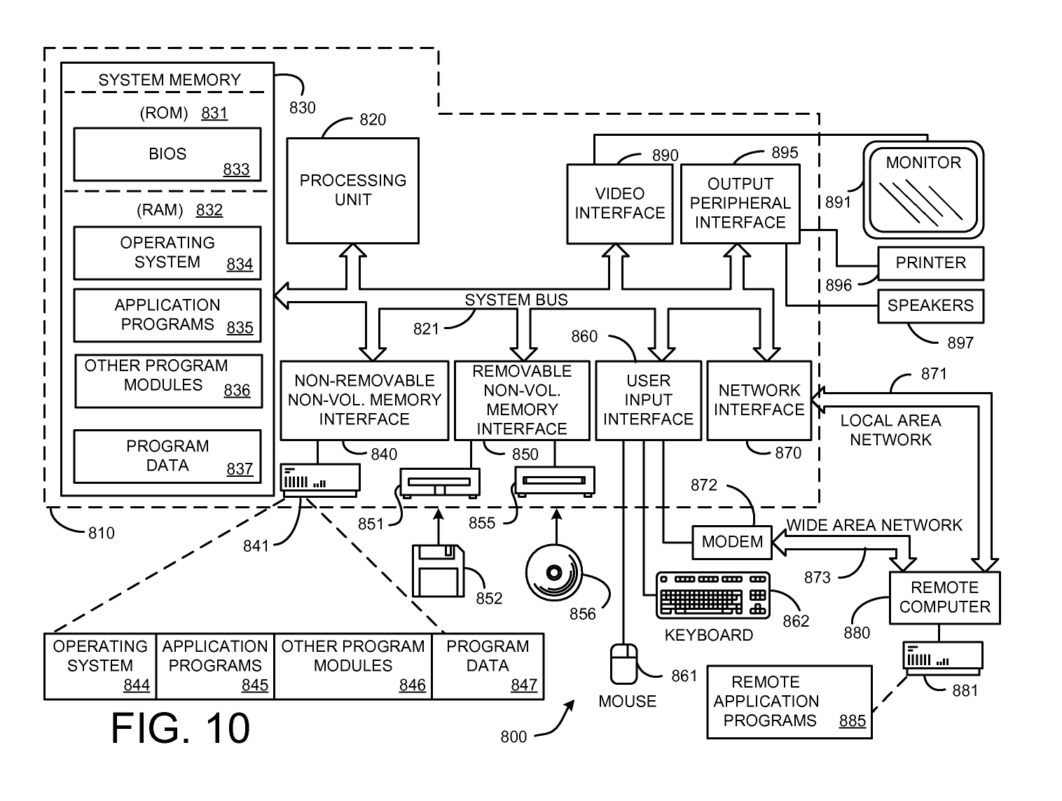

FIG. 10 illustrates an example of a suitable computing system environment in which embodiments of the handwritten paper-based input digital record management system 100 and method shown in FIGS. 1-9 may be implemented. The computing system environment 1000 is only one example of a suitable computing environment and is not intended to suggest any limitation as to the scope of use or functionality of the invention. Neither should the computing environment 1000 be interpreted as having any dependency or requirement relating to any one or combination of components illustrated in the exemplary operating environment.

Embodiments of the handwritten paper-based input digital record management system 100 and method are operational with numerous other general purpose or special purpose computing system environments or configurations. Examples of well known computing systems, environments, and/or configurations that may be suitable for use with embodiments of the handwritten paper-based input digital record management system 100 and method include, but are not limited to, personal computers, server computers, hand-held (including smartphones), laptop or mobile computer or communications devices such as cell phones and PDA's, multiprocessor systems, microprocessor-based systems, set top boxes, programmable consumer electronics, network PCs, minicomputers, mainframe computers, distributed computing environments that include any of the above systems or devices, and the like.

Embodiments of the handwritten paper-based input digital record management system 100 and method may be described in the general context of computer-executable instructions, such as program modules, being executed by a computer. Generally, program modules include routines, programs, objects, components, data structures, etc., that perform particular tasks or implement particular abstract data types. Embodiments of the handwritten paper-based input digital record management system 100 and method may also be practiced in distributed computing environments where tasks are performed by remote processing devices that are linked through a communications network. In a distributed computing environment, program modules may be located in both local and remote computer storage media including memory storage devices. With reference to FIG. 10, an exemplary system for embodiments of the handwritten paper-based input digital record management system 100 and method includes a general-purpose computing device in the form of a computer 1010.

Components of the computer 1010 may include, but are not limited to, a processing unit 1020 (such as a central processing unit, CPU), a system memory 1030, and a system bus 1021 that couples various system components including the system memory to the processing unit 1020. The system bus 1021 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 1010 typically includes a variety of computer readable media. Computer readable media can be any available media that can be accessed by the computer 1010 and includes both volatile and nonvolatile media, removable and non-removable media. By way of example, and not limitation, computer readable media may comprise computer storage media and communication media. Computer storage media includes volatile and nonvolatile removable and non-removable media implemented in any method or technology for storage of information such as computer readable instructions, data structures, program modules or other data.

Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer 1010. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 1030 includes computer storage media in the form of volatile and/or nonvolatile memory such as read only memory (ROM) 1031 and random access memory (RAM) 1032. A basic input/output system 1033 (BIOS), containing the basic routines that help to transfer information between elements within the computer 1010, such as during start-up, is typically stored in ROM 1031. RAM 1032 typically contains data and/or program modules that are immediately accessible to and/or presently being operated on by processing unit 1020. By way of example, and not limitation, FIG. 10 illustrates operating system 1034, application programs 1035, other program modules 1036, and program data 1037.

The computer 1010 may also include other removable/non-removable, volatile/nonvolatile computer storage media. By way of example only, FIG. 10 illustrates a hard disk drive 1041 that reads from or writes to non-removable, nonvolatile magnetic media, a magnetic disk drive 1051 that reads from or writes to a removable, nonvolatile magnetic disk 1052, and an optical disk drive 1055 that reads from or writes to a removable, nonvolatile optical disk 1056 such as a CD ROM or other optical media.

Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 1041 is typically connected to the system bus 1021 through a non-removable memory interface such as interface 1040, and magnetic disk drive 1051 and optical disk drive 1055 are typically connected to the system bus 1021 by a removable memory interface, such as interface 1050.

The drives and their associated computer storage media discussed above and illustrated in FIG. 10, provide storage of computer readable instructions, data structures, program modules and other data for the computer 1010. In FIG. 10, for example, hard disk drive 1041 is illustrated as storing operating system 1044, application programs 1045, other program modules 1046, and program data 1047. Note that these components can either be the same as or different from operating system 1034, application programs 1035, other program modules 1036, and program data 1037. Operating system 1044, application programs 1045, other program modules 1046, and program data 1047 are given different numbers here to illustrate that, at a minimum, they are different copies. A user may enter commands and information (or data) into the computer 1010 through input devices such as a keyboard 1062, pointing device 1061, commonly referred to as a mouse, trackball or touch pad, and a touch panel or touch screen (not shown).

Other input devices (not shown) may include a microphone, joystick, game pad, satellite dish, scanner, radio receiver, or a television or broadcast video receiver, or the like. These and other input devices are often connected to the processing unit 1020 through a user input interface 1060 that is coupled to the system bus 1021, but may be connected by other interface and bus structures, such as, for example, a parallel port, game port or a universal serial bus (USB). A monitor 1091 or other type of display device is also connected to the system bus 1021 via an interface, such as a video interface 1090. In addition to the monitor, computers may also include other peripheral output devices such as speakers 1097 and printer 1096, which may be connected through an output peripheral interface 1095.

The computer 1010 may operate in a networked environment using logical connections to one or more remote computers, such as a remote computer 1080. The remote computer 1080 may be a personal computer, a server, a router, a network PC, a peer device or other common network node, and typically includes many or all of the elements described above relative to the computer 1010, although only a memory storage device 1081 has been illustrated in FIG. 10. The logical connections depicted in FIG. 10 include a local area network (LAN) 1071 and a wide area network (WAN) 1073, but may also include other networks. Such networking environments are commonplace in offices, enterprise-wide computer networks, intranets and the Internet.

When used in a LAN networking environment, the computer 1010 is connected to the LAN 1071 through a network interface or adapter 1070. When used in a WAN networking environment, the computer 1010 typically includes a modem 1072 or other means for establishing communications over the WAN 1073, such as the Internet. The modem 1072, which may be internal or external, may be connected to the system bus 1021 via the user input interface 1060, or other appropriate mechanism. In a networked environment, program modules depicted relative to the computer 1010, or portions thereof, may be stored in the remote memory storage device. By way of example, and not limitation, FIG. 10 illustrates remote application programs 1085 as residing on memory device 1081. It will be appreciated that the network connections shown are exemplary and other means of establishing a communications link between the computers may be used.

The foregoing Detailed Description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A method for digital record management, comprising:
receiving handwritten input from a user using a pen to fill out a paper form using input strokes received by computing device as digital data; and
simultaneously generating a paper version of the paper form and an electronic version of the paper form containing the input strokes; and
manipulating and processing the digital data immediately after receiving the handwritten input from the user.

2. The method of claim 1, further comprising providing verification to the user for each of the input strokes.

3. The method of claim 2, further comprising:
receiving handwritten data;
performing calculations with the handwritten data to obtain a result;
generating audio feedback of the handwritten data and the result; and
outputting the audio feedback of the handwritten data and the result as the data is received.

4. The method of claim 1, further comprising:
automatically calculating any computations needed by the paper form to obtain a result; and
notifying the user of the result in a visual or an audio feedback so that the user can write the result in a corresponding location on the paper form.

5. The method of claim 1, further comprising:
performing a validity check on the handwritten input to ensure that the digital data is valid; and
if the digital data is invalid, then:
not allowing exiting of an application;
not allowing saving of transaction data;
informing the user that the digital data is invalid and prompting the user to correct the handwritten input;
if the digital data is valid, then:
allowing the application to be exited; and
allowing the transaction data to be saved.

6. The method of claim 1, further comprising:
inputting a selected location on the paper form selected by the user using the pen;
mapping the selected location on the paper form to a pre-assigned digital function associated with the selected location; and
performing the pre-assigned digital function associated with the selected location.

7. The method of claim 1, further comprising enforcing a completeness and a validation of the paper form to ensure that all necessary sections of the paper form are completed.

8. The method of claim 7, further comprising:
inputting a filled-in electronic version of the paper form;
inputting a form completeness template that contains information about which areas of the paper form need to be completed; and
comparing the form completeness template and the filled-in electronic version to determine whether the paper form is complete.

9. The method of claim 8, further comprising:
determining that the paper form is not complete;
preventing the user from submitting the filled-in electronic version of the paper form;
notifying the user that the paper form is incomplete; and
prompting the user to complete any incomplete sections of the paper form.

10. The method of claim 9, further comprising:
determining that the paper form is complete; and
allowing the user to save the filled-in electronic version of the paper form.

11. A method for obtaining a paper version of a form and an electronic version of the same form, comprising:
determining a type of the form that is being used;
placing the paper version of the form on a digital computing device;
having a user handwrite input strokes on the paper version of the form to fill in the form;
performing character recognition on the input strokes to simultaneously fill in the paper version of the form and the electronic version of the form;
providing audio feedback and verification to the user each time the user handwrites on the paper version of the form; and
obtaining a completed paper version of the form and a completed electronic version of the form.

12. The method of claim 11, further comprising:
accessing a database to find the electronic version of the form being used;
loading the electronic version of the form into a memory of the digital computing device; and
loading a form update template and a form completeness template into the memory of the digital computing device.

13. The method of claim 12, further comprising:
performing a calculation with at least some of the input strokes to obtain a result;
reporting to the user the result; and
having the user handwrite the result on the paper version of the form to fill in the result on the electronic version of the form.

14. The method of claim 13, further comprising:
determining that updates on the form are needed;
determining a location on the form to place the update based on the form update template; and
updating the location on the form to provide an updated form.

15. The method of claim 14, further comprising:
generating audio feedback for each character represented by the input strokes; and
outputting the audio feedback in real time as the character is received as handwritten input.

16. The method of claim 15, further comprising comparing the form completeness template with a filled in electronic version of the form to determine whether the form has been filled in completely.

17. The method of claim 16, further comprising:
if the form has not been filled in completely, then preventing the user from submitting the filled in electronic version of the form;
notifying the user that the form is incomplete; and
prompting the user to complete incomplete section of the form.

18. The method of claim 16, further comprising:
if the form has been filled in completely, then allowing the user to submit the filled in electronic version of the form; and
outputting a completed paper version of the form and a completed electronic version of the form.

19. A method for aiding a user in completing a paper form using a digitizing surface computing device, comprising:
determining a type of the paper form being used;
loading an electronic version of the paper form into a memory of the digitizing surface computing device;
receiving input strokes that are handwritten characters on the paper form;
performing character recognition on the input strokes to digitize the input strokes and create digital data corresponding to the paper form;
providing audio feedback and verification of each character to the user each time the handwritten character is received as input;
simultaneously generating the paper form and an electronic version of the paper form;
updating the electronic version of the paper form in real time to provide any current data and to report any upcoming information that may be needed;
enforcing that the paper form is completed prior to submitting the electronic version of the paper form; and
outputting a completed paper form and a corresponding completed electronic version of the paper form.

20. The method of claim 19, further comprising manipulating and processing the digital data immediately after receiving the handwritten input strokes.
